(19) United States
(12) Patent Application Publication
(10) Pub. No.: US 2019/0178717 A1
(43) Pub. Date: Jun. 13, 2019

(54) REMOTE MONITORING

(71) Applicant: EKKOSENSE LTD., Lincoln, Lincolnshire (GB)

(72) Inventors: Stuart Redshaw, Nottingham, Nottinghamshire (GB); Dean Boyle, Nottingham, Nottinghamshire (GB); Paul Milburn, Nottingham, Nottinghamshire (GB)

(21) Appl. No.: 16/089,790

(22) PCT Filed: Mar. 30, 2017
(86) PCT No.: PCT/GB2017/050887

§ 371 Date: Sep. 28, 2018

(30) Foreign Application Priority Data
Mar. 31, 2016 (GB) 1605432.2

(51) Int. Cl. G01J 5/02; G01J 5/08

(52) U.S. Cl. CPC G01J 5/025; G01J 5/026; G01J 5/089

(57) ABSTRACT

A method and apparatus for monitoring a remote location, such as a data centre, and in particular updating a computer model representation of the remote location based on measured temperature readings. The method includes: i) identifying a measurement point in a computer model representation of the remote location; ii) selecting an infrared temperature sensor in the computer model capable of taking a temperature measurement of the measurement point; iii) determining an orientation for the infrared temperature sensor to assume to take the temperature measurement of the measurement point; iv) instructing the infrared temperature sensor at the remote location to orient itself according to the determined orientation and to take a temperature measurement; v) receiving the temperature measurement from the infrared temperature sensor at the remote location; and vi) updating the computer model representation to assign a temperature to the measurement point based on the received temperature measurement.

### CROSS-REFERENCE TO RELATED APPLICATIONS

This Application is a Section 371 National Stage Application of International Application No. PCT/GB2017/050887, filed Mar. 30, 2017, the content of which is incorporated herein by reference in its entirety, and published as WO 2017/168154 on Oct. 5, 2017, in English.

### FIELD OF INVENTION

The invention relates to monitoring a remote location, such as a data centre, and in particular to updating a computer model representation of the remote location based on measured temperature readings.

### BACKGROUND

Remote sensing has been variously defined but is basically the art or science of telling something about an object without touching it. Traditionally this area has been confined to observing objects that were too far away to measure in any other way. In the case of equipment rooms in general and data centres in particular the inherent complexity and safety concerns make remote sensing particularly attractive as a means of acquiring data.

Infrared, discovered in 1800 by the British astronomer William Herschel (1738-1822) extends from 0.72 to 15 μm (more than 40 times as wide as the visible spectrum). Because of its range the infrared region encompasses wavelengths with varied properties although two principal categories are recognised. The first consists of the near and mid infrared radiation which lie closest to the visible spectrum. Radiation in the near infrared region behaves, with respect to optical systems, in a manner analogous to radiation in the visible spectrum. Therefore, remote sensing in the near infrared can be done with cameras intended for use with visible light.

The second category of infrared radiation consists of the far infrared region, with wavelengths well beyond the visible, extending into regions that border the microwave region. This radiation is fundamentally different from that in the visible and near infrared. Far infrared radiation is emitted by all objects and can be used as a measure of thermal energy or heat and its measurement can be used to gather information on the temperature of objects.

The typical name for a remote sensor gathering data in the infrared is a thermal camera. Thermal cameras have been utilised for industry applications for decades. As a single use diagnostic tool they are unsurpassed in their ability to acquire an image of an object enabling all of the surface temperatures to be readily understood and described. However, the excellent image resolution available with modern thermal cameras comes at a substantial economic cost. Portable cameras of this capability are generally utilised to diagnose thermal issues after a problem has been detected by other means.

A unique attribute of critical equipment such as server racks as opposed to traditional infrared targets is that they have a slow rate of thermal change (<1 degree/minute) and they tend not to move in the short term but are subject to periodic layout changes. Therefore traditional sensing in these locations is complicated by the continual need to re-position conventional sensors.

Remote monitoring of locations such as data centres and other places where sensitive equipment is operated may typically involve positioning of temperature sensors at strategic places to obtain a thermal picture of the remote location. If any changes are made at the remote location, for example through movement, addition or removal of equipment, a site visit may be required to adjust and reposition any thermal sensors. Each site visit adds to the cost of monitoring the remote location.

### SUMMARY

In accordance with the invention there is provided a method of monitoring a remote location, comprising:
i) identifying a measurement point in a computer model representation of the remote location;
ii) selecting an infrared temperature sensor in the computer model capable of taking a temperature measurement of the measurement point;
iii) determining an orientation for the infrared temperature sensor to assume to take the temperature measurement of the measurement point;
iv) instructing an infrared temperature sensor at the remote location to orient itself according to the determined orientation and to take a temperature measurement;
v) receiving the temperature measurement from the infrared temperature sensor at the remote location; and
vi) updating the computer model representation to assign a temperature to the measurement point based on the received temperature measurement.

The method allows a detailed thermal picture or map of a remote location to be built up and updated, and made accessible via a computer model representation of the remote location. Orienting the infrared temperature sensor to each measurement point allows the use of more economical infrared sensors over more expensive thermal imaging cameras, allowing more sensors to be placed at the remote location to cover a greater number of measurement points. This also allows for coverage of a remote location in a way that can more easily accommodate changes in layout, for example due to equipment being moved, added or removed, without the need for a site visit each time a change is made.

The method allows for a much greater granularity and accuracy of temperature monitoring in a remote location, since one infrared temperature sensor can be used for multiple temperature readings. The method also enables much more efficient optimisation of thermal management, for example in data centres and other environments where thermal management is critical for efficient operation, in that the accumulated information from the remote location can be used to prompt human intervention or automatic action to improve operational performance.

The step of selecting an infrared temperature sensor may comprise selecting from a plurality of infrared temperature sensors capable of taking a temperature measurement of the measurement point. The infrared temperature sensor may be selected based on a determined line of sight between each of the plurality of infrared temperature sensors and the measurement point. A projected field of view may be defined for each of the plurality of infrared temperature sensors at the measurement point, the infrared temperature sensor having the smallest projected field of view being selected.

The selected infrared temperature sensor may be instructed to move to a measurement location in the remote location corresponding to a measurement location in the computer model representation. The selected infrared temperature sensor may be moveable along a path to a range of measurement locations.

Steps i) to vi) may be repeated for a first plurality of measurement points in the computer model. The first plurality of measurement points may, for example, correspond to points designated in the computer model for regular temperature monitoring at the remote location. In some embodiments, i) to v) may be repeated for a second plurality of measurement points, which may for example correspond to points that have not been designated in the computer model for regular temperature monitoring to update the model but are included in regular scans of the remote location to determine if there are any locations with anomalous temperature readings. A received temperature measurement from one of the second plurality of measurement points may, for example trigger a warning or other event if the temperature measurement deviates by more than a predetermined amount from a preset temperature. This may, for example, be used to determine points that might be overheating and that are not subject to regular monitoring. A warning can then be used to determine what action to take, if any.

The plurality of measurement points may be ordered such that movement of the infrared temperature sensor at the remote location between successive temperature measurements is minimised. Minimising movement between temperature measurements allows for a greater number of measurements to be taken over a given time period.

The remote location may be a data centre comprising a plurality of equipment racks arranged in rows with aisles between rows of equipment racks having floor vents for providing air flow. Each of a plurality of thermal imaging cameras in the remote location may be arranged to view one or more of the equipment racks.

The selected infrared temperature sensor may comprise a range finding sensor, the step of receiving a temperature measurement further comprising receiving a distance measurement between the selected infrared temperature sensor and the measurement point, the method further comprising comparing the distance measurement with a distance determined from the computer model between the selected infrared temperature sensor and the measurement point. An alert may be generated by the computer model if the distance measurement differs from the distance determined from the computer model by more than a predetermined amount.

The selected infrared temperature sensor may comprise a directional microphone, the step of receiving a temperature measurement further comprising receiving an audio signal from the directional microphone. The received audio signal may be compared to a stored value in the computer model to determine a state of operation of equipment at the measurement point.

An item of ventilation equipment at the remote location may be instructed to change its state of operation in dependence on the received temperature measurement. The item of ventilation equipment may for example be an air handling unit or a floor tile vent at the remote location, the item of ventilation equipment being instructed to increase or decrease air flow or to increase or decrease a temperature of air passing through the item of ventilation equipment. The temperature of the air may be adjusted by altering an amount of power supplied to an air chiller unit, while the air flow may be adjusted by altering a speed of a fan for driving air through the item of ventilation equipment.

In accordance with a second aspect there is provided a computer program comprising instructions to cause a computer to perform the method according to the first aspect.

### BRIEF DESCRIPTION OF THE DRAWINGS

The invention is described in further detail below, with reference to the accompanying drawings in which:

FIG. 1 is a schematic drawing of a camera viewing an object, indicating the azimuth angle and inclination angle of the direction of view;

FIG. 2 is a schematic plan view of a camera viewing an object, indicating a field of view of the camera;

FIG. 3 is a schematic plan view of a camera moveable along a single linear axis;

FIG. 4 is a perspective cutaway view of a data centre with two cameras in position along an aisle between banks of equipment;

FIG. 5 is a plan view of a camera moveable along a path;

FIG. 6a is a plan view of multiple cameras positioned within a data centre, with one camera having the best line of sight to a desired measurement point;

FIG. 6a is a perspective view from the location of the camera in FIG. 6a having the best line of sight;

FIG. 7a is a plan view of multiple cameras positioned within the data centre of FIG. 6a, with a different camera having the best line of sight to a desired measurement point after removal of some equipment;

FIG. 7b is a perspective view from the location of the camera in FIG. 7a having the best line of sight;

FIG. 8a is a perspective view of two cameras having differing lines of sight to a measurement point;

FIG. 8b is a plan view of the two cameras in FIG. 8a relative to the measurement point;

FIG. 9 is a plan view of a camera relative to a measurement point;

FIG. 10 is a plan view of different positions for a camera able to travel along a linear track;

FIG. 11a is a plan view showing a potential field of view of a camera in a data centre;

FIG. 11b is a plan view of the data centre of FIG. 12a with an equipment rack removed;

FIG. 12 is a perspective side view of a row of equipment racks, with a series of measurement points indicated;

FIG. 13a is a perspective side view of a row of equipment racks, with a series of measurement points indicated together with a suggested additional measurement point;

FIG. 13b is an example screenshot showing notifications of potential new measurement points;

FIGS. 14a and 14b are perspective views of a computer model representation of a data centre, indicating a rifle sight user interface for determining a measurement point;

FIG. 15 is a perspective view of a computer model representation of a data centre, indicating representative areas of an equipment rack having derived average temperatures;

FIG. 16 is a perspective view of a computer model representation of a data centre, indicating floor tiles having a derived average temperature;

FIG. 17 is an infrared thermal image of an equipment rack derived from interpolated temperature measurements;

FIG. 18 is a schematic diagram indicating an example architecture for communications between thermal imaging cameras at a remote location and a computer model of the remote location;

FIG. 19 is a flow diagram indicating a basic procedure of acquiring a temperature measurement at a remote location;

FIG. 20 is a flow diagram of a routine performed when adding a thermal imaging camera at a remote location;

FIG. 21 is a flow diagram for checking for a faulty thermal imaging camera;

FIG. 22 is a flow diagram of an example routine for checking the temperature of measurement points in a remote location and alerting a user to changes; and

FIG. 23 is a perspective view of a computer model representation of a data centre, indicating different zones within the data centre.

### DETAILED DESCRIPTION OF ILLUSTRATIVE EMBODIMENTS

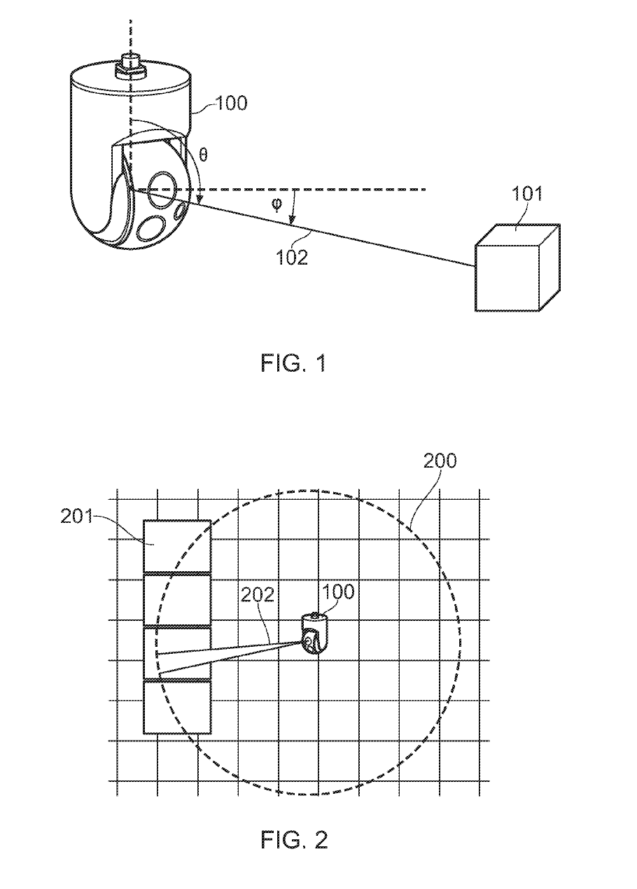

FIG. 1 illustrates schematically an example thermal imaging camera 100 in relation to an object 101 to be measured. The camera 100 is capable of being rotated about two orthogonal axes, allowing the centre of a field of view of the camera 100, indicated by line 102, to be directed to any point within an overall 360° field around the camera 100. The azimuth (or horizontal) angle φ and inclination (or vertical) angle θ of the camera 100 can be set remotely via a network connection, allowing the field of view to be directed to any chosen measurement point within the camera's overall potential field of view. The network connection may for example be a power over Ethernet (PoE) connection, or may be a wired or wireless connection with a separate power connection. A PoE connection typically provides up to around 13 W of power, which is more than adequate for devices such as IP enabled cameras, which typically draw around 3 W. The orientation of the field of view may be adjusted by operating motors in the camera to control the azimuth and inclination. The motors may for example be stepper motors having position feedback.

The camera 100 may be mounted on a ceiling, wall or other location within a location to be remotely monitored. Typical dimensions of such cameras are around 80 mm diameter and 150 mm in length.

The camera 100 may be directed remotely by a computer to rotate to a specified azimuth and inclination and acquire a measurement. The measurement may be as limited as a temperature measurement taken with a single pixel sensor directed to a measurement point identified by the direction the camera 100 is rotated to. A multi-pixel sensor array may alternatively be used, which may return a measurement indicating the temperature of each pixel or an average value from all of the pixels. In each case a defined field of view of the temperature measurement will be an area around the centre of the field of view, i.e. the point at which the direction 102 intersects with an object 101. In such embodiments the camera 100 is used only as an infrared temperature sensor. In alternative embodiments, the measurement may also include a photograph or video of the field of view, which can be used to provide further information about objects within the camera's field of view. The measurement is then transmitted to a computer over the network connection. As described in further detail below, the camera 100 may be instructed to take multiple measurements at different measurement points, transmitting measurement data back to the instructing computer after each measurement.

To allow each measurement taken at the remote location to be accurately linked to a corresponding point in the computer model, it is important that the position and orientation of each infrared temperature sensor at the remote location is accurately known. The position can be accurately determined when each sensor is installed at the remote location. The orientation, which may be determined by rotational encoding sensors may, however, need to be calibrated before a measurement can be reliably linked to a point in the computer model. To allow for this, the sensor may comprise a laser pointer and an image sensor, the laser pointer being aligned with the direction of the infrared imaging sensor. An image taken with the laser pointer enabled will therefore indicate where the sensor is pointed at the remote location. This image can be compared with the expected measurement point from the computer model and any adjustments necessary can be made. An alternative way of providing a calibration for orientation is to incorporate a reference orientation into the sensor, which may be taken as a zero position. The reference orientation may for example be provided by a reference datum that can be detected by an optical sensor. Once the temperature sensor unit is fixed in place at the remote location, the orientation of the unit only needs to be manually determined once. The infrared temperature sensor may then be configured to return to the reference datum position after a tour of measurements and recalibrate its orientation with reference to the reference datum. During each tour of measurements, orientation of the temperature sensor may be determined using a gyroscope, for example based on an accelerometer and magnetometer. Any errors that may build up over time from readings taken using the gyroscope can be corrected by recalibrating the sensor orientation with respect to the reference orientation.

To transfer the position and orientation of each sensor at the remote location to a measurement stored in the computer model, a ray tracing routine may be used in the computer model that project a line of sight from a sensor location to a measurement point in the model, the line of sight being based on the position and orientation of a corresponding sensor at the remote location.

FIG. 2 illustrates schematically in plan view a camera 100 and an associated circular volume 200 (which in practice, if the camera is ceiling-mounted, is a hemisphere centred on the camera 100). The camera can be directed to measure the temperature of any object in view within this volume 200. The diameter of the volume 200 is set by a maximum measurement range of the camera 100, for example determined by a maximum permissible error in temperature measurement, which will tend to increase with distance. An object, such as an equipment rack 201, is shown as being within this volume 200, and the camera 100 is directed to various points along the visible face of the rack 201 to measure temperature. This enables, for example, measurements to be made of air temperature exiting or entering ventilation ports on the rack 201. The field of view 202 of the camera is indicated as a triangle with an apex at the camera lens, representing a conical shape, which intersects with a face of the rack 201. The intersection between the conical field of view and the object to be measured defines an area across which temperature is measured. This area will increase as the measurement distance increases, and will change shape, i.e. from circular to elliptical, as the angle between the direction of the field of view and the face moves away from normal.

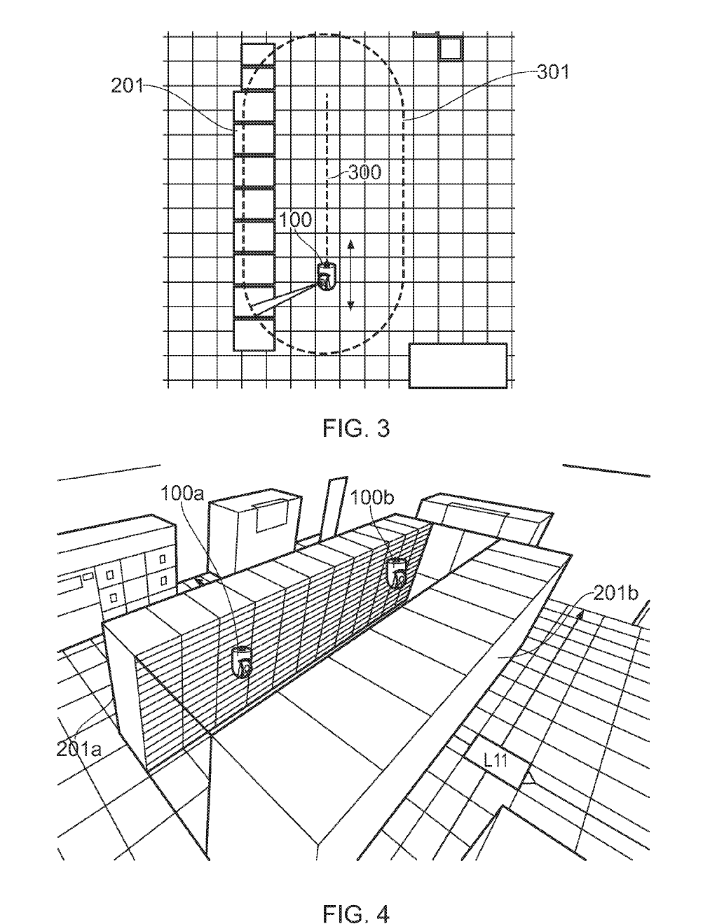

The camera 100 may be mounted in a fixed position within the remote location to be monitored. The camera 100 is preferably rigidly mounted to enable accurate and repeatable orientation measurements. In some embodiments the camera 100 may be moveable, for example along a predefined path as illustrated in FIG. 3. In this example embodiment the camera 100 is moveable along a linear path 300, which may be aligned to be parallel with a face of an equipment rack 201. The resulting measurement volume 301 is extended so that a single camera 100 can measure a longer equipment rack 201 than would otherwise be possible with a fixed camera. The incident angle of each measurement can also be made smaller, i.e. with the direction of field of view closer to normal for each measurement. The position of the camera 100 along the linear path will be provided for each measurement, enabling the camera to move to a location along the path to take each measurement or series of measurements. The linear path 300 may be provided in the form of a rail along which the camera 100 is configured to move, with a linear position along the rail indicated by an encoder.

An example of two fixed location cameras 100a, 100b positioned within an aisle between adjacent equipment racks 201a, 201b is shown in FIG. 4. The cameras 100a, 100b can together take temperature measurements along the faces of each rack, which in this example are faces where ventilation air is taken in and exhausted from the racks. Measurements of temperature along the faces can therefore indicate where any ‘hot spots’ may be occurring, allowing action to be taken if any particular temperature is excessive, for example by altering the ventilation through floor tiles in the aisle.

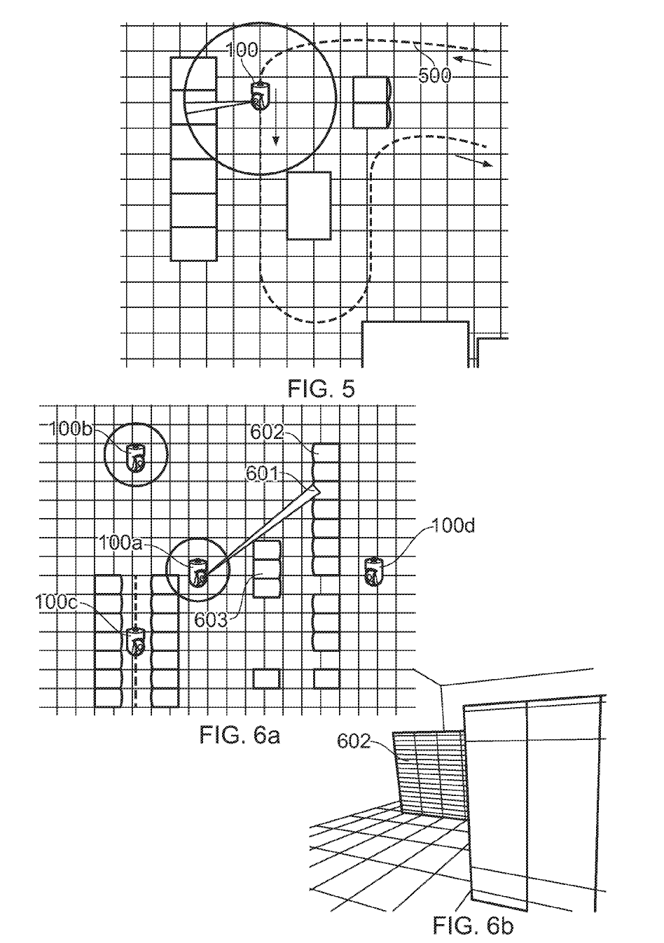

A further optional alternative embodiment is illustrated in FIG. 5, in which a camera 100 is able to move along a path 500 of arbitrary shape. The path 500 may for example be defined by a track installed in the ceiling of the location to be monitored, or may be a defined path for a robotic camera to follow along the floor. An advantage of a ceiling mounted path is that, once established, the position of the camera can be known with accuracy depending only on the position along the path. A disadvantage, however, is the need for a permanent fixture to be placed in the location. An advantage of a robotic camera moving along the floor of the location is that a path can be determined by the instructing computer and changed without the need for physically accessing the remote location, and allowing a larger area to be measured with a single camera. Provided the robotic camera can locate and orient itself within the remote location, for example by triangulation from beacon points or by following predefined markings along the floor, measurements can be taken of specific points by instructing the camera to move to a specified location and take a measurement at a specified azimuth and inclination.

The instructing computer, which will typically be in connection with multiple cameras at the remote location via a network connection, can determine which camera is in the best position to measure temperature at any given measurement point. This calculation is done based on a computer model representation of the remote location, in which all of the cameras and other objects in the location are plotted. FIG. 6a illustrates schematically a portion of a computer model of a data centre with four cameras 100a-d located at different positions to allow measurements to be taken of various racks of equipment within the data centre. While the examples described herein use a data centre to illustrate embodiments of the invention, it will be understood that the invention may be implemented with other locations where temperature measurements may be monitored remotely, for example in telecommunications or electrical power supply applications, or in other locations with remotely operated equipment such as pumps or transformers.

A first camera 100a is determined to have the best line of sight to a desired measurement point 601 on an equipment rack 602 because it is the closest, although the incident angle is greater than that from a second camera. Third and fourth cameras 100c, 100d within the data centre do not have a direct line of sight and are discounted. The field of view from the first camera 100a is shown in perspective view in FIG. 6b, which is an output from the computer model representation of the data centre, confirming that the camera can ‘see’, i.e. has a direct line of sight to, the measurement point 601.

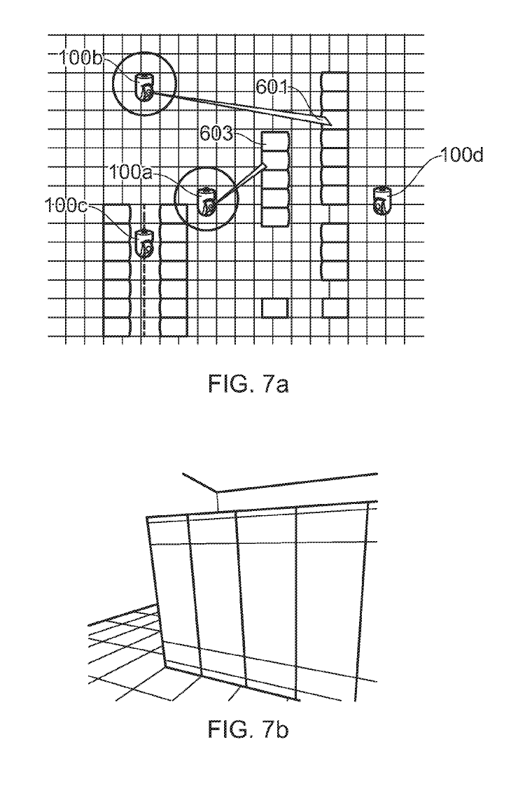

In the event that changes are made at the remote location, for example by removal or addition of one or more equipment racks, the line of sight of a camera may no longer include a measurement point. This is illustrated in FIGS. 7a and 7b, where an addition is made to an equipment rack 603 such that the line of sight from the first camera 100a is now blocked, as confirmed by the view from the camera 100a in FIG. 7b. The instructing computer can then carry out another determination of which camera is best placed to view the measurement point 601, and determines that the second camera 100b is the only one that has a direct line of sight. Instructions are then sent to have the second camera 100b take a measurement of the measurement point 601 in place of the first camera 100a, which can instead be instructed to measure temperatures on the new rack 603.

An important feature is that the computer model representation of the remote location is kept up to date with the physical arrangement of the remote location. It may not always be possible to provide immediate updates on the physical layout of the remote location, but the cameras can be used to determine whether any physical changes have been made. This may be achieved, for example, by taking a photograph for each measurement point, or for a selected proportion of measurement points, and comparing these to the pre-existing computer model representation, which can be viewed from the perspective of any given camera. If there has been any change in the layout of the location this should be immediately evident. One simple way of determining whether any changes have been made is by making a distance measurement when taking any measurement. This can be enabled by including a range finding device on each camera, which can output a distance measurement along with any temperature measurement. If the measured distance does not match the expected distance to the measurement point, as determined by the computer model representation, an error is flagged up and action can be taken to investigate further. An advantage therefore of the invention is that temperature measurements of the remote location can be reconfigured in the event of any changes in equipment at the remote location, typically without the need to physically reconfigure any of the existing temperature sensors. If any physical changes are needed to the temperature sensors, the output of the computer representation can make it clear where any additional sensors will need to be positioned.

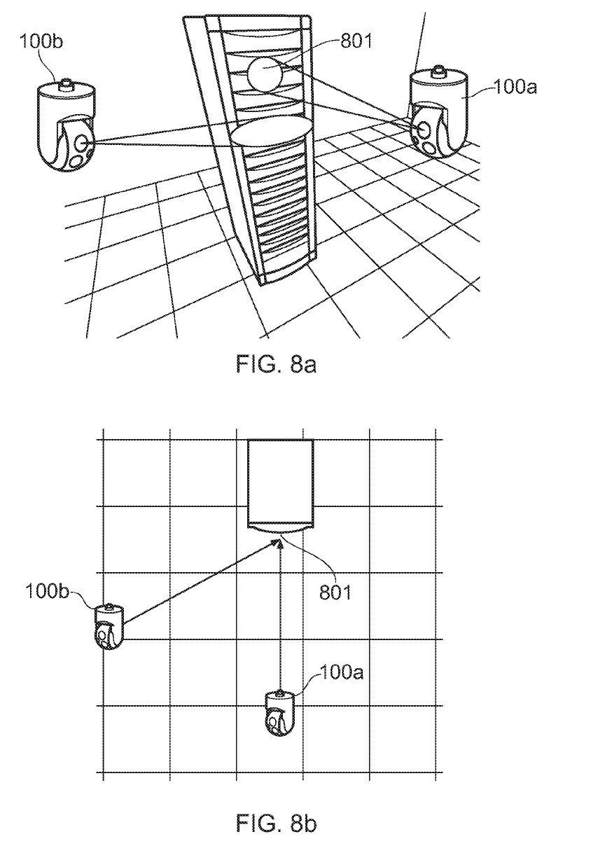

As well as distance to a measurement point, the incident angle between a line connecting any camera with a direct line of sight and the area around the measurement point can be used to determine which camera has the best line of sight. An example is illustrated in FIGS. 8a and 8b, where two cameras 101a, 101b are at roughly equal distances from a desired measurement point 801, but with different angles of incidence. The incident angle for the first camera 100a is zero, resulting in a roughly circular intersection between the field of view and the area around the measurement point. The incident angle for the second camera 100b, however, is around 45°, resulting in an elliptical intersection, substantially larger than that for the first camera 100a. In general terms, the lower the incident angle the more accurate any temperature measurement will be. In this case therefore, the first camera will be selected as the better one for taking the temperature measurement. The incident angle may be used in addition to distance, and may override a preference based on distance if both cameras are within a nominal range from a measurement point.

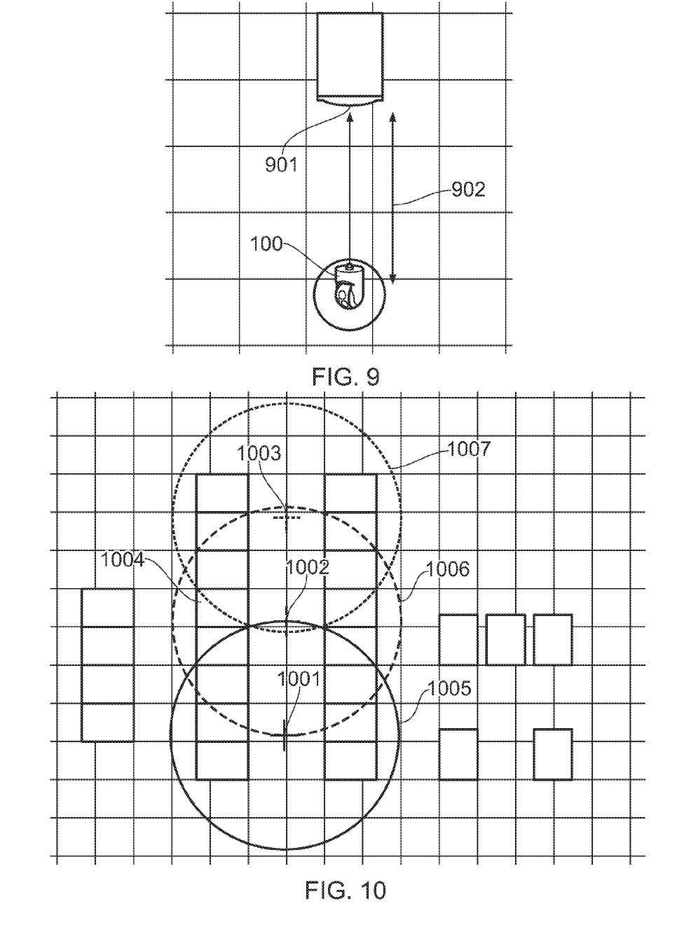

The distance between each camera and any given measurement point can be determined based on the computer model representation of the remote location, as shown schematically in FIG. 9. The relative positions of the camera 100 and the measurement point 901 are both known, allowing the distance 902 to be determined. This can then be used, together with the incident angle, to determine the area of measurement. In some embodiments, this calculated distance can be compared with a measured distance taken by the camera 100, if the camera 100 is equipped with a range finding device. This comparison can then be used to validate the accuracy of the computer model, and for example determine if any changes have been made to the physical location that have not yet been recorded on the model.

Other additional sensing capabilities may be added to the camera. One example is a directional microphone, which may be used for determining acoustic levels around a measurement point, thereby indicating the operational level of an item of equipment at the point such as a fan. Other examples may include an ultrasonic sensor, gas detector, radiation sensor, or any other type of sensor that may provide a measurement of the physical environment around the camera or in the vicinity of the measurement point.

FIG. 10 illustrates an example of different positions a camera may be moved to when taking multiple measurements across a row of equipment racks. In this example, the camera (not shown) is mounted on a linear rail and is able to move to any location along the rail. Moving the camera between positions on the rail, however, takes time and is therefore not necessarily done for each measurement. Instead, the camera may be instructed to move between a limited number of set locations along the path. In the illustrated example the camera moves between three locations 1001, 1002, 1003, which together define three corresponding potential fields of view 1005, 1006, 1007 that cover the entire length of the rack 1004 and within a limited range of incident angles. Based on a maximum permitted incident angle and a given length of rack, the minimum number of positions may be readily calculated based on the maximum distance x between locations being equal to 2dtan θ, where d is the perpendicular distance between the camera and the rack face and θ the maximum angle of incidence, assuming the linear track runs parallel to the rack face.

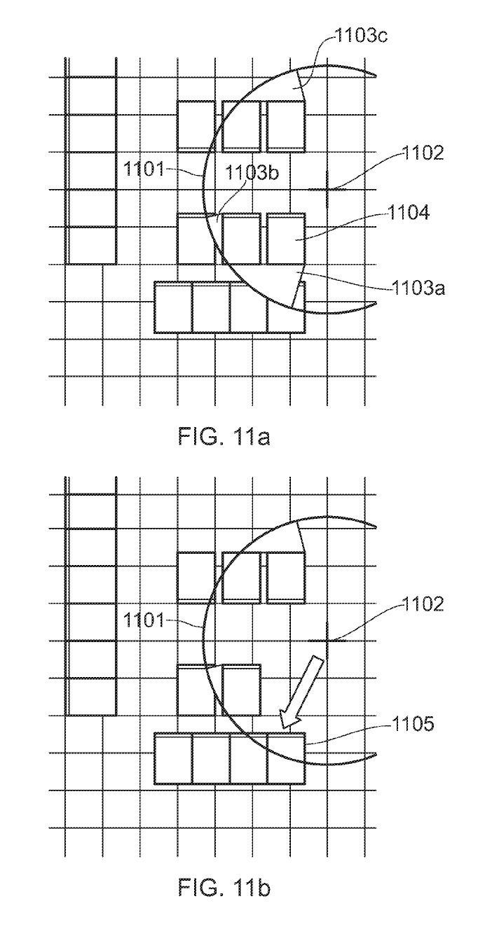

FIGS. 11a and 11b further illustrate the effect of a change in layout of objects in the remote location. FIG. 11 a shows in schematic plan view a potential field of view 1101 of a camera at a location 1102 in a data centre containing multiple equipment racks. Certain areas 1103a-c are obscured from being viewed by the camera, and cannot therefore be measured by the camera. With the removal of equipment rack 1104, however, the area 1103a that was previously obscured is now partly visible, as shown in FIG. 11b, allowing the camera to view an equipment rack 1105 that was previously obscured. Once the computer model is updated to represent this change, temperature measurements can be taken on the equipment rack 1105, or the camera that is now able to see the rack 1105 is selected as a possible choice for taking measurements for this rack.

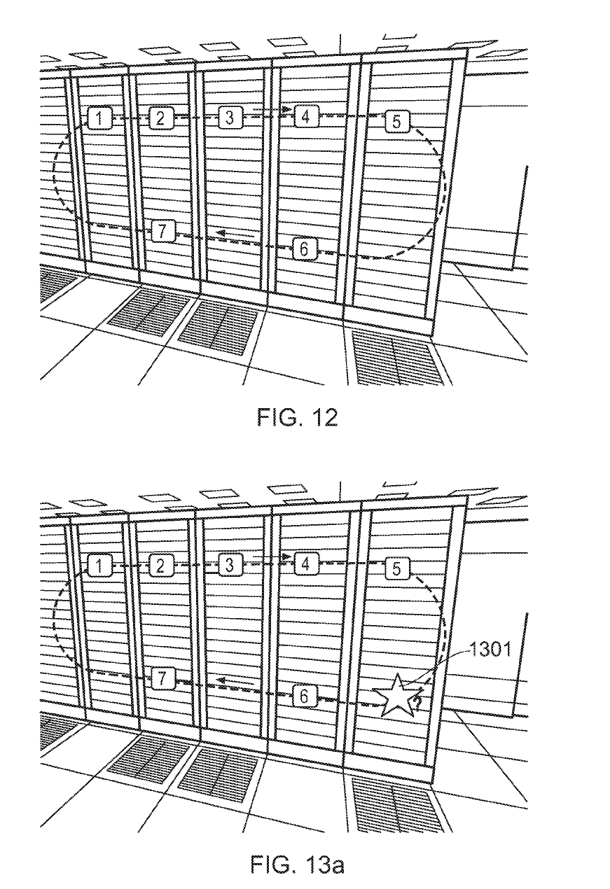

FIG. 12 illustrates an example of how a series of measurement points may be selected and measurements taken in sequence. A number of measurement points (marked 1 to 7) indicate areas of interest along an equipment rack. Each of these points is required to be measured for temperature at regular intervals, which may be set by the instructing computer. The camera will be instructed to perform measurements in a defined sequence, forming a tour of measurements. This tour may be interrupted by a user of the instructing computer, who may instruct the camera to take readings elsewhere within the potential field of view. Once any additional measurements have been taken, the camera resumes the predefined tour. A tour of measurement points across a particular equipment rack may for example be taken every 15 minutes, and an additional ‘idle’ time may be incorporated, for example of 1 minute, to allow for any interruptions to be made without disrupting the measurement tour. In a general aspect therefore, a thermal imaging camera may be instructed to take a series of measurements at different measurement points along a predetermined path, returning temperature measurements for each of the measurement points.

In a typical implementation, a tour of measurement points may involve each sensor acquiring a large number of readings, for example between 60 and 100 readings per minute, or at least one reading per second. Selecting a tour to minimise motion of the sensor between each reading is therefore advantageous in order to reduce the time taken between each reading. It is also advantageous to engineer the sensor to be of a robust construction, with accurate drive motors, bearings and axis position sensing because it will be subject to rapid and frequent movement. In a general aspect therefore, a method of monitoring a remote location that includes multiple measurement points for a sensor may include a step of ordering the measurement points such that movement of the sensor between successive temperature measurements is minimised.

Because multiple temperature readings can be taken with each sensor, the cost of each individual temperature reading can be greatly reduced, to such an extent that every thermally sensitive item of equipment in the remote location that can be viewed by a sensor can in practice be measured and monitored. This reduces the risk of thermal failure in critical environments, thereby allowing items of equipment to be operated closer to their operating limit. A further related advantage is that, due to the increased granularity and accuracy of available temperature information, more advanced control functions can be enabled that can drastically reduce the cost of cooling. Current cooling systems in environments such as data centres typically involve deliberate overcooling to reduce the risk of any equipment overheating and may still involve some overheating as a result of incomplete temperature information. This inevitably costs more than providing an optimum level of cooling, both by using more power than is necessary to provide the cooling and in equipment failures due to overheating. Having a more accurate temperature view of the location enables the level of cooling provided to be closer to a desired optimum level, i.e. providing just enough cooling to prevent overheating of any item of equipment.

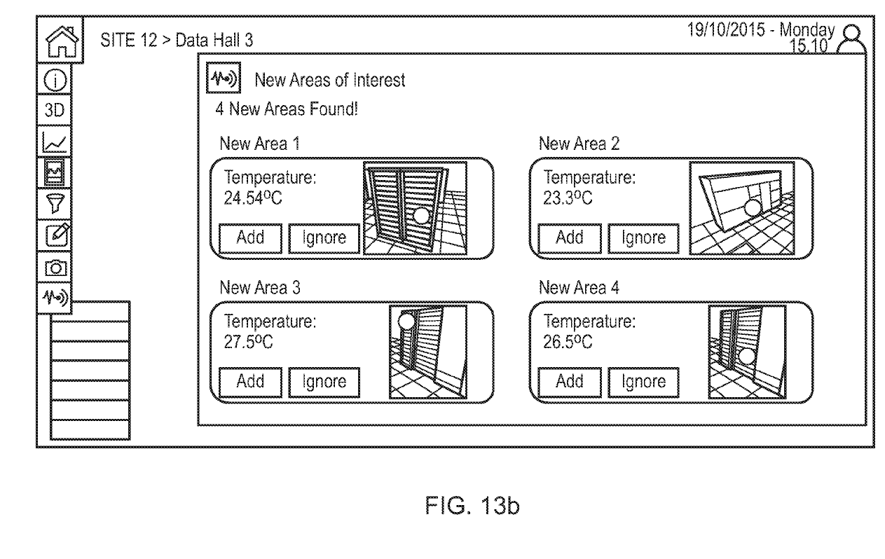

While under normal circumstances measurements are only taken for defined points on a tour of points, as illustrated in FIG. 12, in certain embodiments the camera may provide a more continuous series of measurement data to the instructing computer, allowing additional points of interest to be gathered if needed. As illustrated in FIG. 13a, the tour of measurement points in FIG. 12 may include a new point of interest 1301, which can be automatically determined by the instructing computer on the basis of a temperature anomaly exceeding a predefined range. This new point 1301 may for example be a point on the rack where an item of equipment is overheating, which will require further investigation. The instructing computer may prompt a user to select new measurement points by identifying their location, together with visual representations of the location, in an alert window, as shown in FIG. 13b. The alert window in the illustrated example shows four new areas of interest, where temperatures above a predefined threshold have been measured. In each case, a point is indicated, derived from the computer model representation, of the location of each new point of interest. The user may then select one or more of these new points to be added to an existing tour of measurements, and a temperature map of the remote location can be updated accordingly. In a general aspect therefore, the camera may return additional temperature measurements for other points along the predetermined path, which may be used by the instructing computer to generate additional potential measurement points. The additional potential measurement points may be generated based on a comparison between a measured temperature and a preset temperature range. A potential measurement point may, for example, be generated if a measured temperature falls outside the preset temperature range, i.e. either above or below the range.

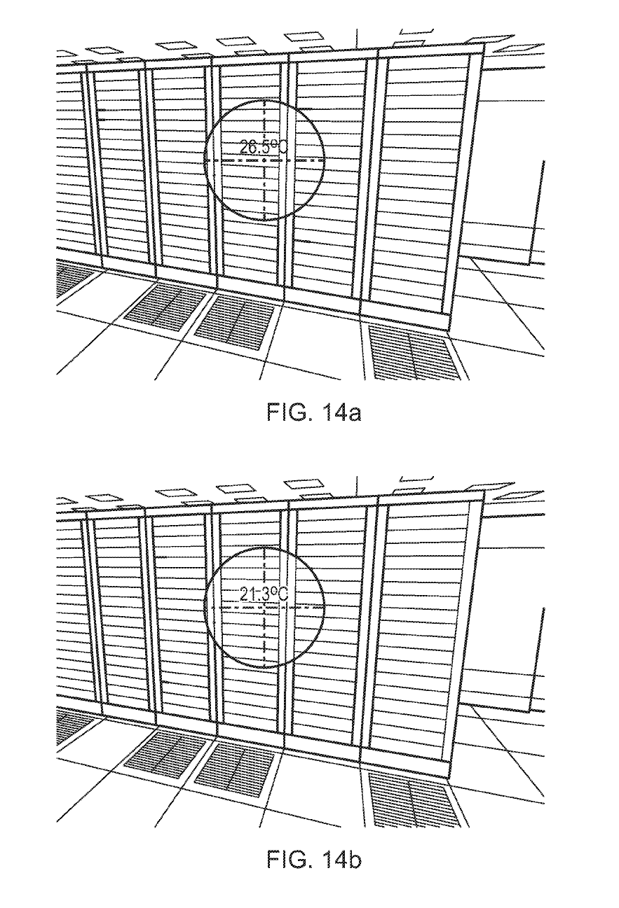

A further option that may be available within the instructing computer is to navigate around the virtual model of the remote location and select measurement points, either to view current data from the remote location or to generate additional measurement points to be included in a temperature measurement routing. FIGS. 14a and 14b illustrate views of an example user interface overlaid on a three dimensional view of a data centre, with the user interface in the form of a rifle scope centred on a measurement point. A current temperature reading, for example determined from a preceding measurement taken by a local camera, may be overlaid on the user interface. The user interface may also be coloured to indicate a temperature range, for example with blue indicating a cooler than nominal temperature and orange or red indicating above nominal temperatures. A particular measurement point may also be selected with the user interface to build up a series of measurements for one or more cameras to take. The use of the virtual model allows a large number of measurement points to be readily selected by moving around the virtual model and selecting points by the simple action of pointing and clicking. The instructing computer can then incorporate these selected points into a series of instructions for cameras installed at the remote location. The virtual model also allows for immediate feedback for a user wishing to investigate the temperature of various locations within the remote location without having to physically attend the location. The virtual model also allows for a user to obtain immediate feedback if any points are not available by virtue of being out of the potential line of sight of any of the cameras currently installed at the remote location. Action can then be taken to remedy this by installing further cameras.

An advantage of the ‘first person’ view shown in FIGS. 14a and 14b, as well as in other drawings, is that the computer model representation of the remote location can be used to display and analyse data so that a human operator can work remotely with greater efficiency and confidence. The view presented to the human operator may be via a computer screen, i.e. as a two dimensional view of a three dimensional modelled space. The view may alternatively be presented as a three dimensional view, either on a screen or via a headset, enabling the operator to immerse themselves in the environment and operate the model more effectively. In further examples, the operator may view the remote location with information from the computer representation overlaid on to a real time image of the remote location, i.e. using augmented reality techniques using information on location and orientation of a viewing camera with information from the computer representation to overlay temperature data and other information on the view presented to the operator.

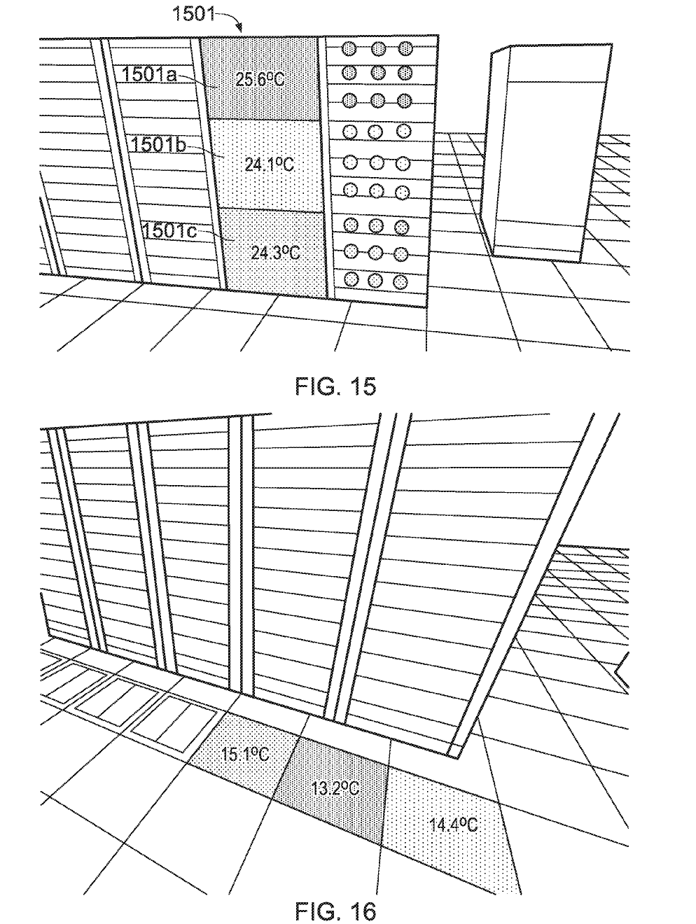

A further feature of the computer model representation may be to correlate various features in the model, such as edges of equipment racks, with temperature measurements in order to provide average readings of representative sections of racks at the remote location. This is illustrated in FIG. 15, where an equipment rack 1501 is divided into three sections 1501a, 1501b, 1501c, with each section having an average temperature defined based on multiple temperature measurements taken previously. Each section may for example be made up of nine separate temperature readings, which are averaged to obtain a temperature for the whole section. In the illustrated example, the lower section 1501c corresponds to an inlet of the equipment rack 1501, and the upper section 1501a corresponds to an outlet. A differential in average temperature between the inlet and outlet sections provides an indication of how effectively the rack is being cooled, and whether the ventilation supplied to the rack is sufficient. For each section multiple readings will typically be taken, being nine for each section in the illustrated example. The number of readings taken may depend on the distance between the camera and the measurement points, for example to compensate for reduced sensor accuracy at increased ranges. An accuracy value may be determined for each reading, or for a collection of readings, which may be based on distance and incident angle of each measurement.

FIG. 16 illustrates a further feature, where temperature measurements may be indicated for floor tiles within a data centre. Such floor tiles are conventionally used for the supply of ventilation (cooling) air to the inlets of adjacent equipment racks. An indication of the temperature of each floor tile can be used to indicate the efficiency of cooling provided, and provides an indication of the temperature of air passing through each tile. Average temperature measurements may be overlaid on each tile, as indicated in FIG. 16, which may be colour coded depending on a temperature scale of cool (blue) to hot (red).

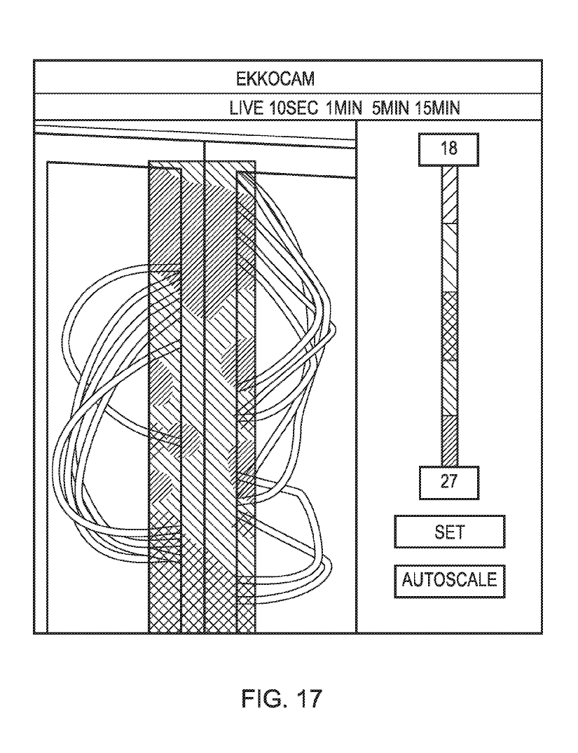

Depending on the number of measurement points available, a more or less detailed thermal map may be overlaid on to a representation of an object at the remote location, as illustrated in FIG. 17. In this example, a face of an equipment rack pictured in a live image is overlaid with colour coded temperature data derived from multiple measurement points. This type of view may be a hybrid image made from camera information together with other information such as manual temperature readings or readings taken from other types of temperature sensors, which may for example be generated in cases where automated infrared temperature sensors have not been fully deployed. The more data points available, the more detailed the thermal map can be. This allows a clearer view to be made of the status of a particular object at the remote location than a single temperature for an area of the object, as in FIG. 15. The interpolated infrared image may be derived from multiple cameras at different angles of incidence, if more than one camera is available for taking measurements.

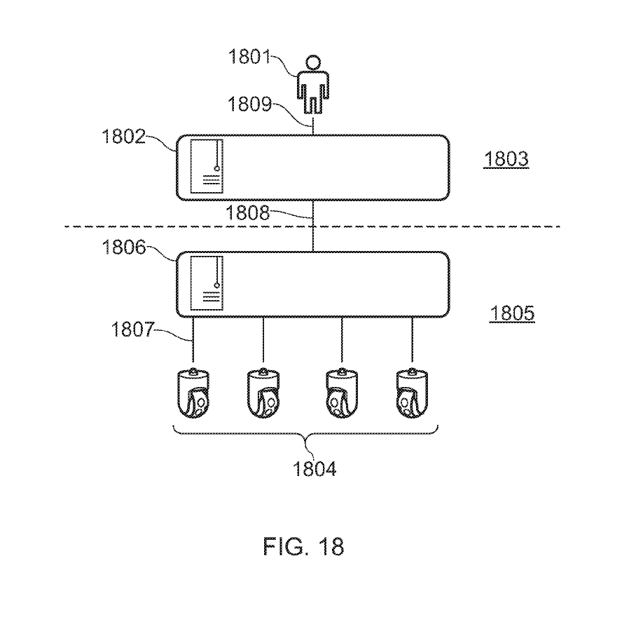

FIG. 18 illustrates schematically an example architecture of a system incorporating temperature measurement at a remote location. A user 1801 interacts with an application layer 1802 in an off-site environment 1803. The off-site environment 1803 may be partly or wholly implemented as a cloud-based application. The application layer 1802 contains software that allows the user 1801 to view current data received from cameras 1804 at the remote location 1805 overlaid on to a computer model representation of the remote location 1805. The software also allows the user 1801 to control various aspects of the remote location 1805, which include controlling operation of a plurality of cameras 1804 at the remote location 1805. An aggregation layer 1806 may be provided at the remote location 1805, which serves to collate and store data from the remote location 1805, such as data from each of the cameras 1804, and to pass data to the application layer 1802 when requested. Each camera is connected to the aggregation layer 1806 via a network connection 1807. The aggregator layer 1806 is connected to the application layer 1802 via a network connection 1808, i.e. the internet. The user 1801 may also be connected to the application layer 1802 via a network connection 1809, if the application layer 1802 is provided as a cloud-based service.

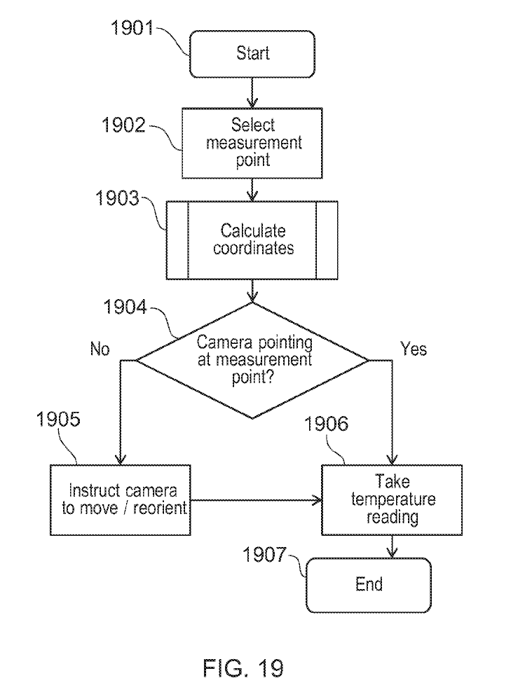

FIGS. 19 to 22 illustrate a series of routines that may be performed by the application layer 1802 to carry out various functions.

FIG. 19 illustrates a routine for carrying out an individual temperature measurement. The routine starts (step 1901) and the user selects a measurement point, for example by clicking on an object to be measured in the computer model representation (step 1902), such as a rack in a data centre model. At step 1903, the software calculates the coordinates for the measurement point and determines, at step 1904, whether the selected camera is pointing at the measurement point. If the camera is pointing at the measurement point, a temperature reading is taken (step 1906). If not, the camera is instructed to move and/or orient itself so that it is pointing at the measurement point (step 1905), following which a temperature reading is taken (step 1906), after which the routine ends (step 1907).

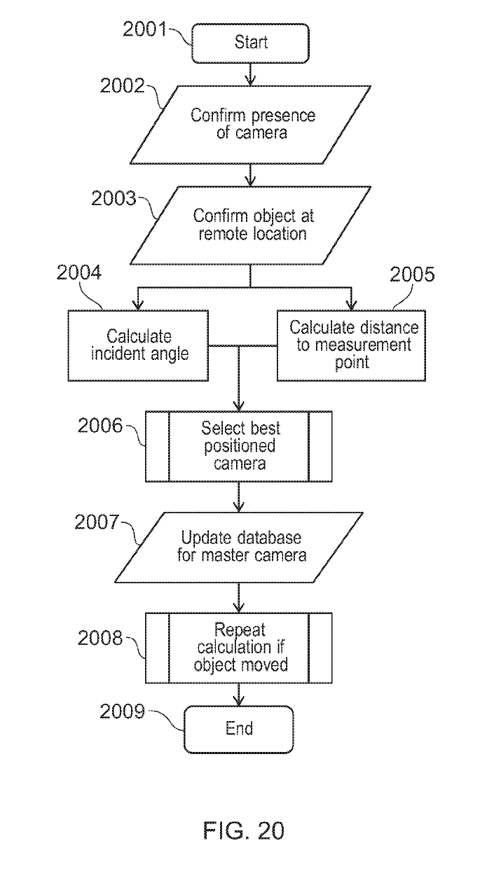

FIG. 20 illustrates a routine for selecting a camera for taking a temperature measurement. The routine starts (step 2001) and two confirmation steps are carried out (steps 2002, 2003). At step 2002 the presence of one or more cameras with location coordinates in the computer model is confirmed. At step 2003 an object at the remote location, such as a rack, and its location coordinates are confirmed. The software then calculates an incident angle (step 2004) and a distance to the measurement point (step 2005) for the or each camera based on the confirmed locations, following which a sub-routine (step 2006) determines which camera is the best to select, if more than one camera is available. At step 2007, the best camera for that measurement location is updated in a database as the ‘master’ camera for the measurement location. At step 2008, a repeat of the calculation is carried out when an object in the computer model representation is moved, when a new object is added or an object removed. The routine then stops (step 2009).

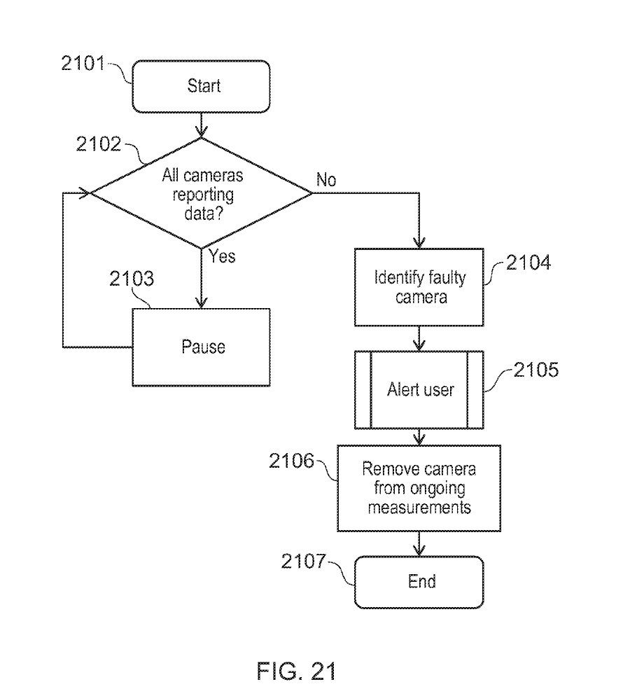

FIG. 21 illustrates a routine for identifying any faulty cameras. The routine starts (step 2101) and a check is carried out to determine if all cameras at the remote location are reporting data (step 2102). If all cameras are reporting data, the routine proceeds to step 2103 where the routine is paused for a set time, for example one hour, following which the check at step 2102 is carried out again. If not all cameras are reporting, the routine proceeds to step 2104 where a faulty camera is identified. An alert is then made for the user to take action (step 2105) and the camera is removed from any ongoing measurements (step 2106) and calculations such as the routine in FIG. 20 for determining a best camera for each measurement point. The routine then stops (step 2107). The routine may then restart checking for the remaining cameras.

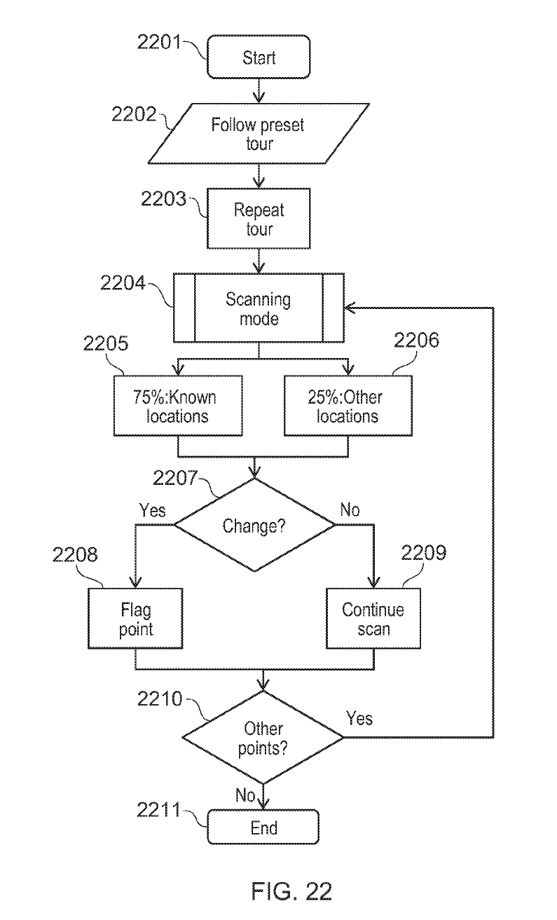

FIG. 22 illustrates a routine for carrying out a series of temperature measurements. The routine starts (step 2201) and a sub-routine is carried out instructing a camera to follow a preset tour of measurement points, collecting and transmitting data from each measurement point (step 2202). The tour repeats at preset intervals (step 2203), for example once every 15 minutes. Once the tour ends, the routine enters a scanning mode (step 2204), where for a proportion of the time (for example 75%) measurements are taken from known measurement points (step 2205), and for the remaining proportion (for example 25%) measurements are taken at locations other than known measurement points (step 2206). If any measurement has changed by more than a preset amount (for example by +/−2° C.) (step 2207), a point is flagged to the user of the software (step 2208). If no change is detected, the process continues to scan (step 2209). After each of steps 2208, 2209, if there are any remaining points to measure (step 2201), the routine then resumes the tour of measurement points. If no measurement points remain to be measured (step 2210), the process ends (step 2211). The overall process may be repeated on a regular basis.

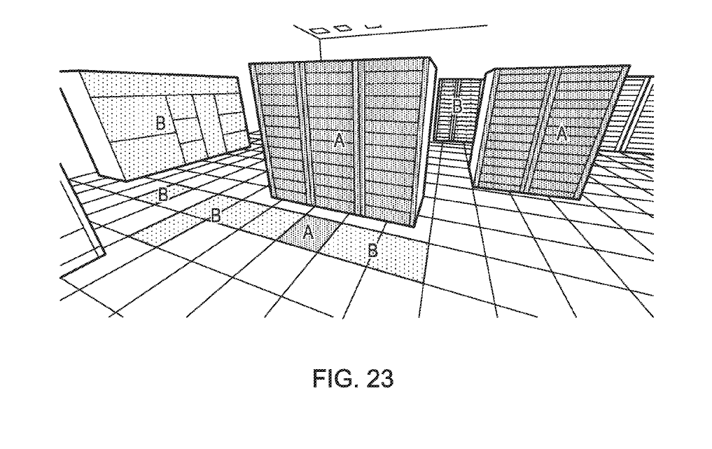

FIG. 23 illustrates a view from a computer model representation of a data centre, with objects identified according to areas to be scanned regularly, for example every 15 minutes, for the database to be kept up to date. The areas labelled ‘A’ are those to be included in a series of measurements for a particular camera, which is identified as being the best one for measurement points in those areas. The areas labelled ‘B’ represent other areas that the camera can see but which are not included in the series of measurements for that camera but which may be measured as additional measurement points when the series of measurements allocated to the camera is complete. A proportion of these areas may be better viewed from a different camera, for example if another camera is closer or has a better more direct line of sight, in which case another camera will carry out temperature measurements.

An overall advantage of the system as described above is that a remote monitoring system can be set up and optimised with a reduced requirement for direct interaction with the remote location once a desired number of networked thermal imaging cameras have been installed. Refinements to the monitoring system can be made remotely, and with the assistance of automated processes that are designed to seek out new measurement points that may be of interest.

Other embodiments are within the scope of the invention, which is defined by the appended claims.

1. A method of monitoring a remote location, comprising the following acts performed by a computer:
i) identifying a measurement point in a computer model representation of the remote location;
ii) selecting an infrared temperature sensor in the computer model capable of taking a temperature measurement of the measurement point;
iii) determining an orientation for the infrared temperature sensor to assume to take the temperature measurement of the measurement point;
iv) instructing the infrared temperature sensor at the remote location to orient itself according to the determined orientation and to take a temperature measurement;
v) receiving the temperature measurement from the infrared temperature sensor at the remote location; and
vi) updating the computer model representation to assign a temperature to the measurement point based on the received temperature measurement.

2. The method of claim 1 wherein the act of selecting an infrared temperature sensor comprises selecting from a plurality of infrared temperature sensors capable of taking a temperature measurement of the measurement point.

3. The method of claim 2 wherein the infrared temperature sensor is selected based on a determined line of sight between each of the plurality of infrared temperature sensors and the measurement point.

4. The method of claim 3 wherein a projected field of view is defined for each of the plurality of infrared temperature sensors at the measurement point, the infrared temperature sensor having the smallest projected field of view being selected.

5. The method of claim 1 wherein the selected infrared temperature sensor is instructed to move to a measurement location in the remote location corresponding to a measurement location in the computer model representation.

6. The method of claim 5 wherein the selected infrared temperature sensor is moveable along a path to a range of measurement locations.

7. The method of claim 1 wherein acts i) to vi) are repeated for a plurality of measurement points in the computer model.

8. The method of claim 7 wherein the plurality of measurement points are ordered such that movement of the infrared temperature sensor at the remote location between successive temperature measurements is minimised.

9. The method of claim 1 wherein the remote location is a data centre comprising a plurality of equipment racks arranged in rows with aisles between rows of equipment racks having floor vents for providing air flow.

10. The method of claim 9 wherein each of a plurality of infrared temperature sensors in the remote location is arranged to view one or more of the equipment racks.

11. The method of claim 1 wherein the selected infrared temperature sensor comprises a range finding sensor, the act of receiving a temperature measurement further comprising receiving a distance measurement between the selected infrared temperature sensor and the measurement point, the method further comprising comparing the distance measurement with a distance determined from the computer model between the selected infrared temperature sensor and the measurement point.

12. The method of claim 11 wherein an alert is generated by the computer model if the distance measurement differs from the distance determined from the computer model by more than a predetermined amount.

13. The method of claim 1 wherein the selected infrared temperature sensor comprises a directional microphone, the act of receiving a temperature measurement further comprising receiving an audio signal from the directional microphone.

14. The method of claim 13 wherein the received audio signal is compared to a stored value in the computer model to determine a state of operation of equipment at the measurement point.

15. The method of claim 1 wherein an item of ventilation equipment at the remote location is instructed to change its state of operation in dependence on the received temperature measurement.

16. The method of claim 15 wherein the item of ventilation equipment is an air handling unit or a floor tile vent at the remote location, the item of ventilation equipment being instructed to increase or decrease air flow or to increase or decrease a temperature of air passing through the item of ventilation equipment.

17. A non-transitory computer-readable medium comprising instructions stored thereon, which when executed by the computer, configure the computer to perform a method of monitoring a remote location, comprising:
i) identifying a measurement point in a computer model representation of the remote location;
ii) selecting an infrared temperature sensor in the computer model capable of taking a temperature measurement of the measurement point;
iii) determining an orientation for the infrared temperature sensor to assume to take the temperature measurement of the measurement point;
iv) instructing the infrared temperature sensor at the remote location to orient itself according to the determined orientation and to take a temperature measurement;
v) receiving the temperature measurement from the infrared temperature sensor at the remote location; and
vi) updating the computer model representation to assign a temperature to the measurement point based on the received temperature measurement.
